(19) United States
(12) Patent Application Publication
(10) Pub. No.: US 2002/0148155 A1
(43) Pub. Date: Oct. 17, 2002

(54) Quick-disconnect spinner blades for fishing lures

(76) Inventor: B. Phil Pasley, Shreveport, LA (US)

Correspondence Address: John M. Harrison, 2139 E. Bert Kouns, Shreveport, LA, 71105, US

(21) Appl. No.: 10/067,638

(22) Filed: Feb. 7, 2002

Related U.S. Application Data
(60) Provisional application No. 60/283,722, filed on Apr. 16, 2001.

(51) Int. Cl. A01K 85/00

(52) U.S. Cl. 43/42.49

(57) ABSTRACT

Quick disconnect spinner blades for fishing lures and particularly spinner bait fishing lures, which blades are characterized by a transverse or planar connecting mechanism in one end or edge for quickly and easily connecting the spinner blades to respective swivel and rotator elements provided on the wire harness of the fishing lures. In a first preferred embodiment, the connecting device includes an offset or transverse-mounted clasp fitted with a spring and designed to quickly and removably secure the spinner blades to the swivel or rotator. In another preferred embodiment, the connecting mechanism is characterized by an offset or transverse-mounted finger lock, also fitted with a spring, for removably securing the spinner blade to the swivel or rotator. In yet another preferred embodiment, the clasp and finger lock are secured to the swivel or rotator by an attachment ring and are designed to removably engage a conventional spinner blade at the blade opening thereof. In still another preferred embodiment of the invention, the clasp and finger lock may be provided in the respective spinner blades in coplanar relationship with respect to the blades and in a further preferred embodiment, the spinner blade is characterized by a slotted blade opening to facilitate attachment of the spinner blade on a swivel or a rotator.

### CROSS-REFERENCE TO RELATED APPLICATIONS

This application claims the benefit of copending U.S. Provisional Application Ser. No. 60/283,722, filed Apr. 16, 2001.

### BACKGROUND OF THE INVENTION

1. Field of the Invention

This invention relates to fishing lures and spinner bait fishing lures in particular, and more particularly, to quick disconnect spinner blades for attachment to the swivel and/or the rotator elements of a spinner blade wire harness to facilitate blade replacement in an optimum manner. In a first preferred embodiment of the invention, the quick disconnect spinner blades are characterized by a clasp spinner blade having an offset or transverse-mounted clasp fitted with a spring and designed for removably engaging the swivel and/or the rotator of the spinner bait for ease in connecting and disconnecting the clasp spinner blade to and from the spinner bait. In another preferred embodiment of the invention, the connecting mechanism is characterized by a finger lock, also provided in offset or transverse-mounted relationship with respect to the plane of the spinner blade, for ease in attachment to the swivel and/or the rotator of the spinner bait harness. In a third embodiment of the invention, both the clasp and finger lock are provided in coplanar orientation in the respective spinner blades and are quickly and easily attached to the swivel and/or the rotator in the same manner as the offset or transverse counterparts. In yet another preferred embodiment of the invention, the clasp and finger lock elements may be secured to the swivel and the rotator by means of attachment rings such as split rings or otherwise, and are removably attached to conventional spinner blades by means of the blade openings provided in the respective blades. In still another preferred embodiment of the invention, a blade slot communicating with a blade opening is provided in each spinner blade to facilitate ease in removable attachment of the spinner blades to the swivel and/or the rotator element of the spinner bait harness.

One of the most effective lures known in taking fish and particularly the highly respected black bass, is the spinner bait lure. These lures are typically characterized by a generally L-shaped, offset wire harness having loop or bend in or near the center thereof for receiving a fishing line and fitted with a body and hook combination at one end and one or more spinners at the opposite, offset end of the harness. The spinner bait also typically has a rubber or plastic skirt which undulates and “swims” as the lure is retrieved through the water. The spinner or spinners extending from the rearwardly projecting, extending offset portion of the wire harness are typically attached by means of a swivel to the end of the wire harness and to a rotator, which is typically spaced from the end of the wire harness by means of beads or other elements, to prevent entanglement of the two rotating spinners as the lure is retrieved. Changing of the spinner blades to suit weather conditions and such variables as water clarity, depth and aquatic content and the like, is difficult, since a pair of pliers must be used to bend the wire loop open at the end of the harness to change swivels and blades or split rings must be used to connect the spinner blade to the swivel and/or to the rotator to facilitate illegal removal of the old blade and attachment of a new one. Since the split rings are characterized by a considerable tension, it sometimes requires a fair amount of time and effort to replace spinner blades on the average and typical spinner bait lure of this design.

2. Description of the Prior Art

Various connectors and the like are known in the art for attaching fishing lures to fishing line and spinner blades to fishing lures. U.S. Pat. No. 4,141,116, dated Feb. 27, 1979, to Zalonis, details a snap swivel for fishing tackle, which includes a band of spring material folded upon itself to form a closed triangle with the ends of the band overlapping on one side of the triangle, shaping a normally closed, but openable passageway into and out of the triangle. Another side of the triangle has a hole in which a swivel pin can turn, the swivel pin being connected to a normally closed, but openable hook element for receiving a fishing accessory. U.S. Pat. No. 4,649,664, dated Mar. 17, 1987, to Mahan, details an apparatus for securing a fishing lure to a fishing line. The apparatus includes an elongated body having spaced pairs of gripping members. A fishing line is inserted through passageways in opposite ends of the body of the apparatus and forms a loop that engages the eye of the fishing lure, secured by engaging gripping members on alternate sides of sequential pairs in the apparatus. U.S. Pat. No. 4,696,120, dated Sep. 29, 1987, to Schroeder, details a fish line snap connector which includes a continuous spring steel member shaped to provide a pair of spring loops, one of the loops providing a first ring for connecting the member to a key ring loop and the second loop arranged along one of the arms of the clip to provide a snap lock force to an engaging hook arranged on the ultimate end of the arm. The unit also provides a pair of spring loops, one at the end of the clip and the other intermediate one of the arms, with two such arms provided and each such arm having connecting hook to provide interconnection to each of the arms. U.S. Pat. No. 5,063,705, dated Nov. 12, 1991, to Pool, details a fishing lure which includes a spacer secured to a fish hook that positions and holds the hook at a predetermined distance and optimum position behind a spinner holding a bait fish. U.S. Pat. No 5,042,191, dated Aug. 22, 1991, to Fett, details a clip for attaching a fishing lure to a line. The clip includes a line-attaching loop and a pair of elongated, diverging tension bars extending symmetrically from free ends of the loop, the tension bars having a pair of inwardly-converging bars carried with overlapping end portions for holding a pair of overlapping loops which are separable by depressing the tension bars between a thumb and forefinger for changing or replacing a fishing lure. U.S. Pat. No. 5,189,826, dated Mar. 2, 1993, to Schlaegel, includes a fishing device having a fixed jaw and a juxtaposed jaw movable into an outer engagement with the fixed jaw. A lever is pivotally secured to the fixed jaw and acts to forceably move the movable jaw toward the fixed and to hold the jaw in clamping engagement with the bait. U.S. Pat. No. 5,537,776, dated Jul. 23, 1996, to Gilard, details a fishing line connector. The connector includes a shank, a coiled member defined by multiple, uniformly spaced coils and having an axial opening therebetween and an open-ended eye loop. The connector provides a knotless connection for a fishing line when the line is wrapped around the coiled member in alternating longitudinal directions and snapped into the open-ended eye loop. U.S. Pat. No. 5,605,004, dated Feb. 25, 1997, to Boullt, details a spinner fishing lure which includes a quick-release closure having a sleeve that slidably engages the wire shaft of the fishing lure arm and a contiguous extension of the fishing lure arm simultaneously. The sleeve may be slid away from the loop, permitting separation of the loop from the arm to attach or change the spinner blade.

It is an object of this invention to provide new and improved quick disconnect spinner blades for fishing lures and spinner bait fishing lures in particular, which quick disconnect blades are characterized by a transverse or planar-mounted, spring-loaded clasp fitted to one edge or end of the spinner blade for quickly and removably attaching the blade to the swivel and/or rotator of the spinner bait fishing lure.

Another object of this invention is to provide quick disconnect spinner blades having a transverse or planar-mounted, spring-loaded finger lock on one edge or end thereof for quickly and removably attaching the spinner blade to the swivel or rotator of a spinner bait fishing lure.

Still another object of this invention is to provide new and improved spring-operated clasps and finger locks for securing to the swivel and/or rotator of the spinner bait type fishing lure, which clasp and finger locks are quickly and removably attached to conventional spinner blades.

Another object of this invention is to provide new and improved spring-operated clasps and finger locks for removable attachment to conventional spinner blades, which clasps and finger locks are connected to a spinner bait fishing lure by means of attachment rings.

Yet another object of this invention is to provide new and improved quick disconnect spinner blades for attachment to the swivel or rotator of a spinner bait fishing lure, which spinner blades are each characterized by a blade opening and a blade slot communicating with the blade opening, which blade slot is slightly undersized with respect to the swivel and/or the rotator to facilitate quickly and removably attaching the spinner blades to the swivel and the rotator.

### SUMMARY OF THE INVENTION

These and other objects of the invention are provided in new and improved quick disconnect spinner blades for fishing lures, which blades are characterized by spring-operated clasps and finger locks attached to the spinner blades in various fashion for quick, easy and removable attachment of the spinner blades to the swivel and rotator, respectively, of the spinner bait fishing lure. In another embodiment, the spinner blades may be fitted with a blade opening communicating with a blade slot which is undersized with respect to the swivel and the rotator to facilitate quickly and removably attaching the blades to the swivel and the rotator, respectively.

### BRIEF DESCRIPTION OF THE DRAWINGS

The invention will be better understood by reference to the accompanying drawings, wherein:

FIG. 1 is a perspective view of a typical spinner bait fishing lure, fitted with a pair of offset or transverse-mounted clasp spinner blades of this invention;

FIG. 2 is a perspective view of one of the clasp spinner blades illustrated in FIG. 1, more particularly defining an offset or transverse-mounted, spring-loaded clasp thereon;

FIG. 3 is a sectional view taken along line 3—3 of the offset or transverse-mounted clasp element illustrated in FIG. 2, with the clasp in closed configuration;

FIG. 4 is a sectional view taken along line 3—3 of the offset or transverse-mounted clasp illustrated in FIG. 2, with the clasp in open configuration;

FIG. 5 is an exploded view of the transverse clasp spinner blade illustrated in FIG. 1, more particularly illustrating the clasp element in open configuration as illustrated in FIG. 4, for attachment to a swivel on the spinner bait harness;

FIG. 6 is a perspective view of a transverse or offset, spring-operated finger lock spinner blade for attachment to the swivel or rotator of the spinner bait illustrated in FIG. 1;

FIG. 7 is a sectional view taken along line 7—7 of the finger lock element illustrated in FIG. 6, with the finger lock illustrated in closed configuration;

FIG. 8 is a sectional view taken along line 7—7 of the finger lock element illustrated in FIG. 6, more particularly illustrating the finger lock in open configuration;

FIG. 9 is a perspective view of the finger lock spinner blade illustrated in FIG. 6, with the transverse finger lock element disposed in open configuration as illustrated in FIG. 8, for attachment to the swivel of the spinner bait lure illustrated in FIG. 1;

FIG. 10 is a perspective view of another embodiment of the invention, wherein a pair of spring-loaded ring clasps are attached by means of an attachment ring to the swivel and rotator elements, respectively, of the spinner bait and are removably secured to a pair of corresponding conventional spinner blades through a blade opening provided in each spinner blade; FIG. 11 is a perspective view of the ring clasp elements illustrated in FIG. 10, with the spinner blades in position for attachment to the ring clasps;

FIG. 12 is a perspective view of the swivel and rotator elements of the spinner bait lure illustrated in FIG. 1, more particularly illustrating attachment of a pair of conventional spinner blades to corresponding spring-operated ring finger lock elements connected to the swivel and rotatable elements, respectively, by means of attachment rings;

FIG. 13 is a perspective view of an in-line or planar clasp spinner blade;

FIG. 14 is a perspective view of an in-line or planar finger lock spinner blade; and

FIG. 15 is a perspective view of a slotted spinner blade.

### DESCRIPTION OF THE PREFERRED EMBODIMENTS

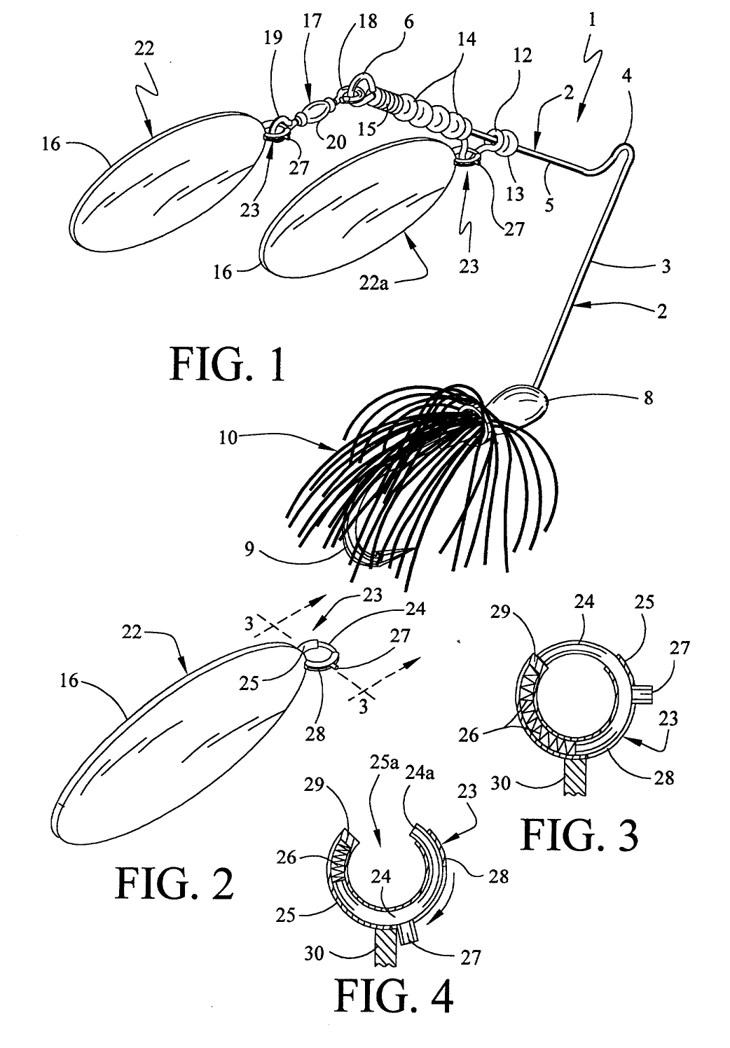

Referring initially to FIGS. 1-5 of the drawings, in a first preferred embodiment the quick disconnect spinner blades of this invention are generally illustrated as an outside clasp spinner blade 22, having a generally elongated, elliptical blade 16 removably connected by means of a transverse clasp 23 to a swivel 17, and an inside clasp spinner blade 22a, the blade 16 of which is removably connected by means of a transverse clasp 23 to a rotator 12, rotatably mounted on the wire harness 2 of a spinner bait fishing lure 1. The spinner bait fishing lure 1 is further characterized by a body 8, attached to the body segment 3 of the wire harness 2, and a bend 4 is provided in the approximate center of the generally L-shaped wire harness 2 for attachment to a fishing line (not illustrated). An eye 6 terminates the extending or offset spinner segment 5 of the wire harness 2. The rotator 12 is designed to rotate on the offset spinner segment 5 and is spaced from the eye 6 by means of multiple rear beads 14 and an optional spacer 15, such as a spring, as illustrated in FIG. 1. The rotator 12 is, in turn, spaced from the bend 4 in the wire harness 2 by means of one or more front beads 13. The spacing of the rotator 12 and the corresponding attached inside clasp spinner blade 22a from the swivel 17 and the connected outside clasp spinner blade 22 is maintained by the rear beads 14 and the spacer 15. The spacing insures that the outside clasp spinner blade 22 and inside clasp spinner blade 22a will not interfere with each other while the inside clasp spinner blade 22a rotates about the offset spinner segment 5 of the wire harness 2 and the outside clasp spinner blade 22 rotates on the swivel 17 as the spinner bait fishing lure 1 is retrieved through the water in conventional fashion. A skirt 10 may also be provided on the body 8 of the spinner bait fishing lure 1 and is generally designed to conceal a hook 9, extending from the body 8.

As further illustrated in FIGS. 2-4 of the drawings, the outside clasp spinner blade 22 and inside clasp spinner blade 22a may be quickly and easily attached to and removed from the respective blade swivel eye 19 (FIG. 1) of the swivel 17 and the rotator 12, respectively, of the spinner bait fishing lure 1, by manipulation of the corresponding transverse clasp 23 as hereinafter described. A sleeve grip 27 is attached to a split clasp ring 24 that is interrupted by a ring gap 24a and is shaped within a “C”-shaped split sleeve 25 of the transverse clasp 23, which split sleeve 25 is interrupted by a sleeve gap 25a. As further illustrated in FIGS. 3 and 4, the sleeve grip 27 is designed to slide in a sleeve slot 28 provided in the sleeve 25, and a spring seat 29 in the sleeve 25 maintains a sleeve spring 26 in position inside the hollow sleeve 25 and against the spring-engaging end of the clasp ring 24. The split clasp ring 24 slides in an arc within the sleeve 25 against the bias of the sleeve spring 26 when pressure is applied to the sleeve grip 27, as further illustrated by the arrow in FIG. 4, to align the ring gap 24a of the clasp ring 24 with the sleeve gap 25a of the sleeve 25 and open the transverse clasp 23, as further illustrated in FIG. 4. The open sleeve gap 25a thus allows the transverse clasp 23 to be fitted either to the blade swivel eye 19 of the swivel 17 or to the rotator 12, as illustrated in FIG. 1. In a typical design, the swivel 17 is characterized by a harness swivel eye 18, secured to the eye 6 of the spinner bait fishing lure 1, and a swivel barrel 20, rotatably receiving the harness swivel eye 18, as well as the blade swivel eye 19, to facilitate rotation of the outside clasp spinner blade 22 with respect to the eye 6 without impediment. As further illustrated in FIGS. 3 and 4, a sleeve mount 30 may connect the transverse clasp 23 to the blade 16 of the corresponding outside clasp spinner blade 22 and inside clasp spinner blade 22a, typically by gluing, soldering, brazing or the like, according to the knowledge of those skilled in the art. Alternatively, the transverse clasp 23 may be attached directly to the blade 16 of the corresponding outside clasp spinner blade 22 or inside clasp spinner blade 22a, as illustrated in FIGS. 1 and 2 and according to the knowledge of those skilled in the art. In either case, the plane of the sleeve 25 of the transverse clasp 23 is disposed in perpendicular or transverse relationship with respect to the plane of the blade 16 of the outside clasp spinner blade 22 and inside clasp spinner blade 22a, respectively.

Referring now to FIGS. 6-9 of the drawings, in another preferred embodiment of the invention, a pair of finger lock spinner blades 32 is provided, each with a transverse finger lock 32a. Each transverse finger lock 32a is characterized by a housing 33, provided with a housing slot 33a and terminating at one end in a curved housing finger 33b. The housing 33 is glued, soldered, brazed or otherwise secured to the blade 16 of the finger lock spinner blade 32, with the plane of the housing 33 disposed in perpendicular or transverse relationship with respect to the plane of the blade 16. A trigger-shaped keeper 34 is pivotally disposed in the housing slot 33a of the housing 33 by means of a pivot pin 38, and the keeper 34 is further characterized by a keeper stay 35, that registers with the housing finger 33b when the transverse finger lock 32a is in the closed configuration illustrated in FIG. 7. A finger tab 36 is shaped in the keeper 34 opposite the keeper stay 35, and a keeper spring 39 typically encircles the pivot pin 38. One end of the keeper spring 39 engages the keeper 34, with the opposite, tensioning end of the keeper spring 39 resting against the housing 33 in the housing slot 33a. Accordingly, the keeper spring 39 serves to normally maintain the keeper 34 in the closed configuration illustrated in FIG. 7, with the finger tab 36 engaging the housing 33 and the keeper stay 35 lying adjacent to the housing finger 33b of the transverse finger lock 32a. Opening of the transverse finger lock 32a is achieved by finger pressure against the finger tab 36 to pivot the keeper 34 against the tension in the keeper spring 39, into the open configuration illustrated in FIG. 8, with the keeper stay 35 rotated downwardly to create an access gap 37, further illustrated in FIG. 8.

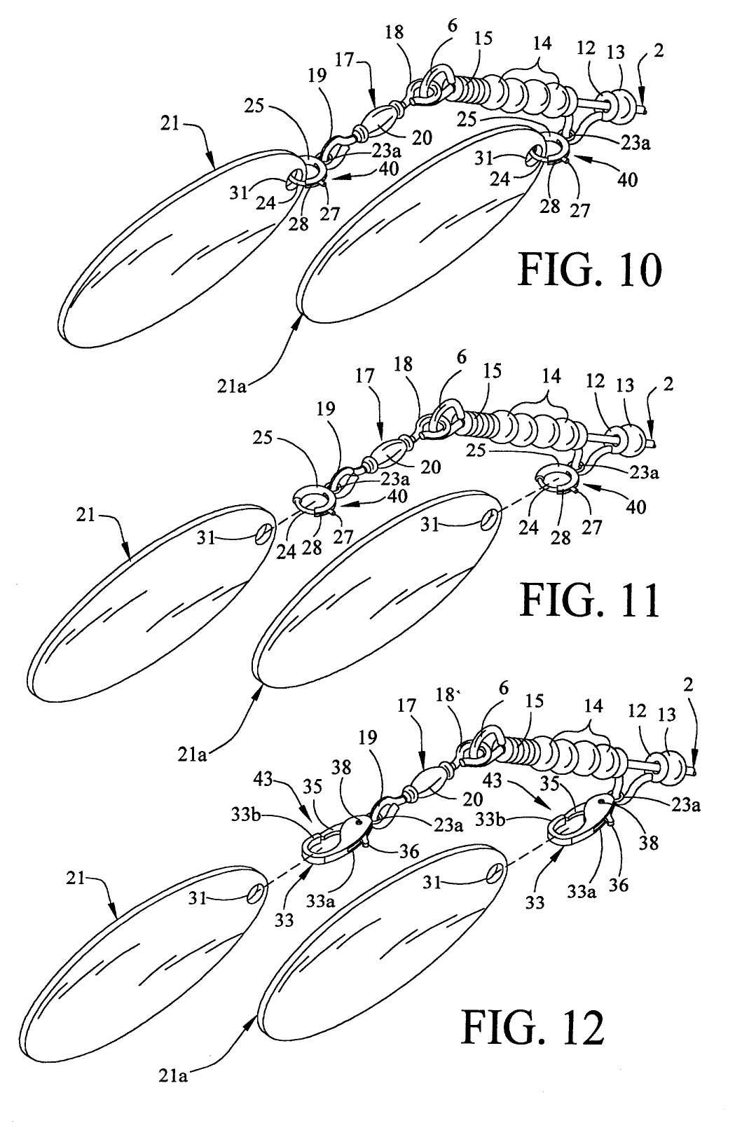

Referring to FIGS. 10 and 11 of the drawings, in yet another preferred embodiment of the invention the sleeve 25 of each of two ring clasps 40 is provided with an attachment ring 23a, which may be a split ring, that encircles the blade swivel eye 19 of the swivel 17 and the rotator 12, respectively, to secure the ring clasps 40 to the swivel 17 and the rotator 12, respectively. Accordingly, the sleeve grip 27 can be manipulated against the tension in the sleeve spring 26 (FIG. 4) in the ring clasp 40 to extend the corresponding clasp ring 24 through the blade opening 31 in an outside conventional spinner blade 21 and an inside conventional spinner blade 21 a and removably secure the outside conventional spinner blade 21 and inside conventional spinner blade 21a to the corresponding ring clasp 40 in each case.

In similar manner, referring to FIG. 12, in still another embodiment the housing 33 of each of two ring finger locks 43 is fitted with an attachment ring 23a for attachment to the blade swivel eye 19 of the swivel 17 in one case and to the rotator 12 in the other, and the ring finger locks 43 are removably attached to a corresponding outside conventional spinner blade 21 and inside conventional spinner blade 21a, each fitted with a blade opening 31 for receiving the ring finger lock 43, as illustrated and as heretofore described with respect to the ring clasps 40 of FIGS. 10 and 11.

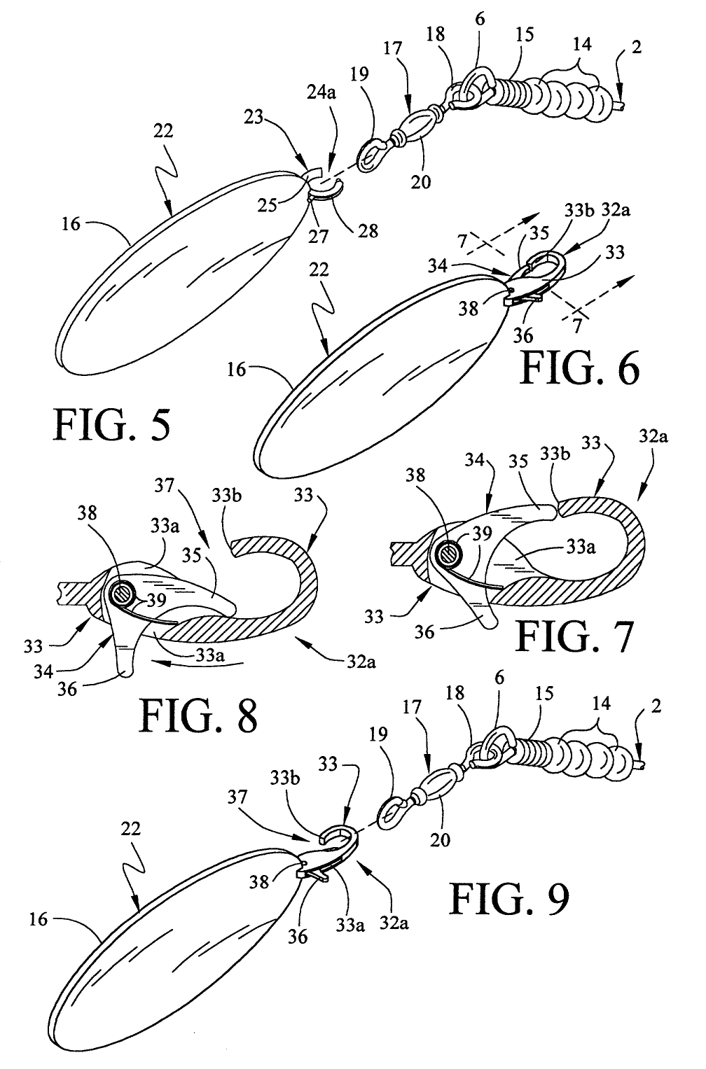

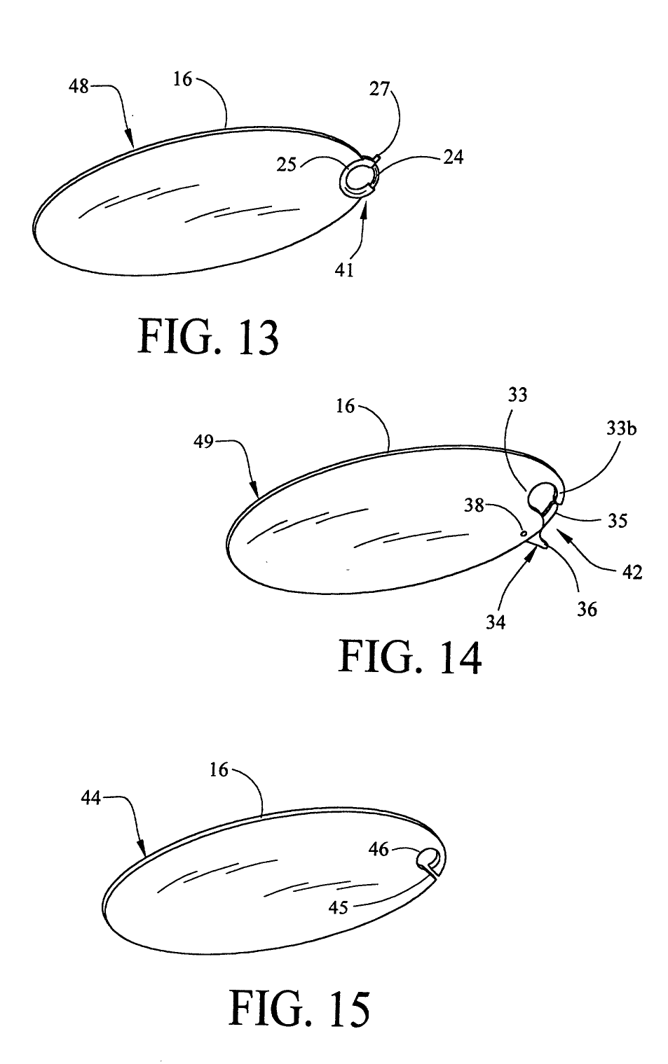

Referring now to FIG. 13 of the drawings, in another preferred embodiment of the invention each of two planar clasp spinner blades 48 is fitted with a corresponding in-line or planar clasp 41, which is structured in the same manner as the transverse clasp 23 illustrated in FIGS. 1-4, but the sleeve 25 and clasp ring 24 of the inline clasp 41 are in substantial alignment with the plane of the blade 16 of the corresponding planar clasp spinner blade 48. Attachment of the planar clasps 41 to the blade swivel eye 19 of the swivel 17 and to the rotator 12, respectively, of the spinner bait fishing lure 1, is effected in the same manner as above described with respect to the transverse clasp 23 of FIG. 5. Referring to FIG. 14 of the drawings, in still another preferred embodiment of the invention each of two planar finger lock spinner blades 49 for the spinner bait fishing lure 1 is configured with an in-line or planar finger lock 42, structured in the same way as the transverse finger lock 32a heretofore described with respect to FIGS. 6-9, but configured in the same plane as the blade 16 of the planar finger lock spinner blade 49. Accordingly, the housing 33 of the planar finger lock 42, having the housing slot 33a (FIG. 8), is formed integrally with the blade 16. The keeper stay 35 of the keeper 34, pivotally mounted in the housing slot 33a (FIG. 8), can thus be forced inwardly by manipulation of the corresponding finger tab 36 against the bias of the keeper spring 39 (FIG. 8) to facilitate attachment of the planar finger lock spinner blades 49 to the blade swivel eye 19 of the swivel 17 and to the rotator 12, respectively, of the spinner bait fishing lure 1, as heretofore described with respect to the finger lock spinner blade 32.

Referring now to FIG. 15 of the drawings, in yet another preferred embodiment of the invention a slotted spinner blade 44 is provided, and is fitted with a blade slot 45 that extends through the blade 16 of the slotted spinner blade 44, to a blade opening 46. The undersize of the blade slot 45 is chosen such that it can be forced on the blade swivel eye 19 of the swivel 17 and on the rotator 12 in a tight friction fit, such that the slotted spinner blade 44 can be caused to rotate in the same manner as the clasp spinner blades 22 and the finger lock spinner blades 32 as heretofore described, without inadvertent detachment from the blade swivel eye 19 and the rotator 12, respectively, while the spinner bait fishing lure I is retrieved.

It will be appreciated by those skilled in the art that the various quick disconnect spinner blades of this invention facilitate optimum replacement of spinner blades on the harnesses of spinner blade type lures without the use of split rings or the requirement of opening and closing the eye 6 of the wire harness 2 illustrated in FIG. 1 of the drawings. The facility for rapid spinner blade change is particularly important under circumstances where the fisherman is participating in tournament fishing, as time is always of the essence in competition and every effort must be made to keep the lure in the water for as long a period of time as possible. Accordingly, various sizes and shapes of the clasp spinner blades 22 and 22a, finger lock spinner blades 32 and the slotted spinner blades 44 may be provided in the fisherman's tacklebox, including but not limited to, willowleaf, 16 colorado and like spinners.

While the preferred embodiments of this invention have been described above, it will be recognized and understood that various modifications may be made in the invention and the appended claims are intended to cover all such modifications which may fall within the spirit and scope of the invention.

Having described my invention with the particularity set forth above, what is claimed is:

1. A quick disconnect spinner blade for a spinner bait lure, comprising a blade and a spring-loaded locking mechanism provided on said blade for engaging the spinner bait lure and removably attaching said blade to the spinner bait lure.

2. The quick disconnect spinner blade of claim 1 wherein said spring-loaded locking mechanism comprises a clasp characterized by a rounded sleeve having a sleeve gap carried by said blade; a sleeve spring provided in said sleeve; and a rounded clasp ring having a ring gap slidably disposed in said sleeve, whereby said sleeve gap is closed by said clasp ring when said sleeve spring is relaxed in said sleeve and said sleeve gap and said ring gap coincide and said clasp is open when said clasp ring is slidably manipulated in said sleeve against the bias of said sleeve spring.

3. The quick disconnect spinner blade of claim 1 wherein said spring-loaded locking mechanism comprises a finger lock characterized by a housing carried by said blade; a housing slot provided in said housing; a keeper pivotally disposed in said housing slot; and a keeper spring seated in said housing slot, said keeper spring engaging said housing and said keeper, whereby said keeper is normally pivoted into a closed configuration by said keeper spring and said keeper is pivoted into an open configuration against the tension in said keeper spring responsive to finger pressure on said keeper.

4. The quick disconnect spinner blade of claim 1 comprising a blade opening provided in said blade and wherein said spring-loaded locking mechanism removably engages said blade through said blade opening.

5. The quick disconnect spinner blade of claim 4 wherein said spring-loaded locking mechanism comprises a clasp characterized by a rounded sleeve having a sleeve gap engaging said blade at said blade opening; a sleeve spring provided in said sleeve and a rounded clasp ring having a ring gap slidably disposed in said sleeve, whereby said sleeve gap is closed by said clasp ring when said sleeve spring is relaxed in said sleeve and said sleeve gap and said ring gap coincide and said clasp is open when said clasp ring is slidably manipulated in said sleeve against the bias of said sleeve spring.

6. The quick disconnect spinner blade of claim 4 wherein said spring-loaded locking mechanism comprises a finger lock characterized by a housing engaging said blade at said blade opening; a housing slot provided in said housing; a keeper pivotally disposed in said housing slot; and a keeper spring seated in said housing slot, said keeper spring engaging said housing and said keeper, whereby said keeper is normally pivoted into a closed configuration by said keeper spring and said keeper is pivoted into an open configuration against the tension in said keeper spring responsive to finger pressure on said keeper.

7. The quick disconnect spinner blade of claim 4 comprising an attachment ring provided on said spring-loaded locking mechanism for attaching said spring-loaded locking mechanism to the spinner bait lure.

8. The quick disconnect spinner blade of claim 7 wherein said spring-loaded locking mechanism comprises a ring clasp characterized by a rounded sleeve having a sleeve gap attached to said attachment ring; a sleeve spring provided in said sleeve; and a rounded clasp ring having a ring gap slidably disposed in said sleeve, whereby said sleeve gap is closed by said clasp ring when said sleeve spring is relaxed in said sleeve and said sleeve gap and said ring gap coincide and said clasp is open when said clasp ring is slidably manipulated in said sleeve against the bias of said sleeve spring.

9. The quick disconnect spinner blade of claim 7 wherein said spring-loaded locking mechanism comprises a ring finger lock characterized by a housing attached to said attachment ring; a housing slot provided in said housing; a keeper pivotally disposed in said housing slot; and a keeper spring seated in said housing slot, said keeper spring engaging said housing and said keeper, whereby said keeper is normally pivoted into a closed configuration by said keeper spring and said keeper is pivoted into an open configuration against the tension in said keeper spring responsive to finger pressure on said keeper.

10. The quick disconnect spinner blade of claim 1 wherein said spring-loaded locking mechanism is transversely mounted on said blade.

11. The quick disconnect spinner blade of claim 10 wherein said spring-loaded locking mechanism comprises a transverse clasp characterized by a rounded sleeve having a sleeve gap transversely mounted on said blade; a sleeve spring provided in said sleeve; and a rounded clasp ring having a ring gap slidably disposed in said sleeve, whereby said sleeve gap is closed by said clasp ring when said sleeve spring is relaxed in said sleeve and said sleeve gap and said ring gap coincide and said clasp is open when said clasp ring is slidably manipulated in said sleeve against the bias of said sleeve spring.

12. The quick-disconnect spinner blade of claim 10 wherein said spring-loaded locking mechanism comprises a transverse finger lock characterized by a housing transversely mounted on said spinner blade; a housing slot provided in said housing; a keeper pivotally disposed in said housing slot; and a keeper spring seated in said housing slot, said keeper spring engaging said housing and said keeper, whereby said keeper is normally pivoted into a closed configuration by said keeper spring and said keeper is pivoted into an open configuration against the tension in said keeper spring responsive to finger pressure on said keeper.

13. The quick-disconnect spinner blade of claim 2 wherein said clasp is disposed in substantially the same plane as said blade.

14. The quick disconnect spinner blade of claim 3 wherein said finger lock comprises an inline finger lock and said housing is disposed in substantially the same plane as said blade.

15. A quick disconnect spinner blade for a spinner bait lure having a spinner harness, a swivel mounted on one end of the spinner harness and a rotator rotatably mounted on the spinner harness, said quick disconnect spinner blade comprising a blade and an inline clasp provided on said blade for removable attachment to the swivel and the rotator of the spinner bait lure, respectively, said inline clasp characterized by a rounded split sleeve provided on said blade, a sleeve spring provided in said sleeve; and a rounded split ring slidably disposed in said sleeve, whereby said inline clasp is closed when said sleeve spring is relaxed in said split sleeve and said inline clasp is open when said ring is slidably manipulated in said split sleeve against the bias of said sleeve spring.

16. The quick-disconnect spinner blade of claim 15 comprising a blade opening provided in said blade and wherein said clasp removably engages said blade through said blade opening.

17. A quick disconnect spinner blade for a spinner bait lure having a spinner harness, a swivel mounted on one end of the spinner harness and a rotator rotatably mounted on the spinner harness, said quick disconnect spinner blade comprising a housing carried by the swivel and the rotator, respectively, said housing engaging said blade; a housing slot provided in said housing; a keeper pivotally disposed in said housing slot; and a keeper spring seated in said housing slot, said keeper spring engaging said housing and said keeper, whereby said keeper is normally pivoted into a closed configuration by said keeper spring and said keeper is pivoted into an open configuration against the tension in said keeper spring responsive to finger pressure on said keeper.

18. The quick disconnect spinner blade of claim 17 comprising a blade opening provided in said blade and wherein said housing removably engages said blade through said blade opening.

19. A quick disconnect spinner blade for a spinner bait lure having a spinner harness, said quick disconnect spinner blade comprising a blade; a blade slot provided in said blade; and a blade opening communicating with said blade slot for receiving the spinner harness through said blade slot and removably attaching said blade to the spinner bait lure.

20. The quick disconnect spinner blade of claim 19 wherein the spinner harness is fitted with a swivel and the swivel is inserted in said blade slot and said blade opening.
